(19) United States
(12) Patent Application Publication
(10) Pub. No.: US 2026/0257966 A1
(43) Pub. Date: Sep. 3, 2026

(54) A MECHANOCHEMICALLY CARBONATED NATURAL POZZOLAN, METHODS OF ITS PRODUCTION AND USES THEREFOF

(71) Applicant: CARBON UPCYCLING TECHNOLOGIES INC., Calgary (CA)

(72) Inventor: Apoorva SINHA, Calgary (CA)

(73) Assignee: CARBON UPCYCLING TECHNOLOGIES INC., Calgary, AB (CA)

(21) Appl. No.: 19/101,274

(22) PCT Filed: Aug. 16, 2023
(86) PCT No.: PCT/IB2023/058223

§ 371 Date: Feb. 5, 2025

(30) Foreign Application Priority Data
Aug. 17, 2022 (EP) 22190792.6

(51) Int. Cl. C04B 7/12; C04B 7/36; C04B 7/52

(52) U.S. Cl. CPC C04B 7/12; C04B 7/367; C04B 7/52

(57) ABSTRACT

The present invention relates to a mechanically carbonated natural pozzolan which has a specific surface area within the range of 0.5-50 m²/g. The invention further relates to methods of its production and uses thereof, for example as a filler or binding agent. The invention further relates to compositions comprising the mechanically carbonated natural pozzolan and a further material selected from the group consisting of asphalt, cement, geopolymers, polymers and combinations thereof and methods of their production.

### FIELD OF THE INVENTION

The present invention relates to a mechanically carbonated natural pozzolan. The invention further relates to methods of its production and uses thereof, for example as a filler or binding agent. The invention further relates to compositions comprising the mechanically carbonated natural pozzolan and a further material selected from the group consisting of asphalt, cement, geopolymers, polymers and combinations thereof and methods of their production.

### BACKGROUND ART

Concrete is a composite material, comprising a matrix of aggregate (typically a rocky material) and a binder (typically Portland cement or asphalt), which holds the matrix together. Concrete is one of the most frequently used building materials and is said to be the second most widely used material on earth, after water.

In order to reduce the cost of concrete and the CO₂ emissions generated by global cement production, much research effort has been dedicated to identifying cheap material which can be used as a filler or alternative binder to replace the binder component without (detrimentally) affecting the properties of concrete. Such secondary cementitious materials are an area of broad industry interest.

An example of a widely employed cement filler is limestone. A comprehensive overview of fillers in cementitious materials can be found in John, Vanderley M., et al. “Fillers in cementitious materials—Experience, recent advances and future potential.” Cement and Concrete Research 114 (2018): 65-78.

The production of Portland cement contributes to about 8% of world carbon dioxide emissions. According to Vanderley et al. the traditional mitigation strategies for CO₂ emissions in the cement industry are not sufficient to ensure the necessary mitigation in a scenario of increasing cement demand. Currently, cement production is increasing due to a combination of increasing urbanization and replacement of old infrastructure. Therefore, the adoption of expensive and environmentally risky carbon capture and storage (CCS) has been considered an unavoidable solution by cement industry leaders.

Hence, there remains a need to develop affordable filler technology which can combine both the CO₂ emission reduction achieved by reduced cement production and the CO₂ emission reduction achieved by carbon capture technology and which does not detrimentally affect the properties of concrete.

It is an object of the present invention to provide improved fillers for cement or asphalt binder.

It is a further object of the present invention to provide improved fillers for cement, geopolymer or asphalt binder which are cheap to produce.

It is a further object of the present invention to provide improved fillers for cement, geopolymer or asphalt binder which are produced using CO₂ storage technology.

It is a further object of the present invention to provide improved fillers for cement, geopolymer or asphalt binder which improve the properties of the resulting concrete, such as the compressive strength, the strength activity index and/or the water demand.

### SUMMARY OF THE INVENTION

In a first aspect the present invention provides a mechanochemically carbonated natural pozzolan which preferably has a specific surface area within the range of 0.05-50 m²/g and preferably is obtainable by carbonation of a natural pozzolan precursor wherein,
the ratio of the total carbon content of the mechanochemically carbonated natural pozzolan to the total carbon content of the natural pozzolan precursor is at least 1.5:1, preferably at least 2:1, more preferably at least 2.5:1; and/or.
the ratio of the CO₂ content of the mechanochemically carbonated natural pozzolan to the CO₂ content of the natural pozzolan precursor is at least 1.1:1, preferably at least 1.3:1, more preferably at least 1.4:1, wherein the CO₂ content is determined as the mass loss above 450° C. measured by TGA employing a temperature trajectory wherein the temperature was increased from room temperature to 800° C. at a rate of 10° C./min.

EP3744700B1 concerns carbonation of recycled concrete fines, which is not a natural pozzolan.

VIZCAYNO C ET AL: “Pozzolan obtained by mechanochemical and thermal treatments of kaolin” APPLIED CLAY SCIENCE, ELSEVIER, AMSTERDAM, NL, vol. 49 no. 4, 1 Aug. 2010 pages 405-413 describes grinding of kaolin in an air atmosphere to increase its pozzolanic activity. As is shown in the appended examples the carbonated natural pozzolans of the present invention have surprisingly and strongly improved strength activity indexes at day 7 and day 28 compared to the air-milled counterparts.

In another aspect, the invention provides a method for producing a mechanochemically carbonated natural pozzolan, said method comprising the steps of:
a) providing a feedstock comprising or consisting of a natural pozzolan precursor;
b) providing a gas comprising CO₂, preferably comprising at least 0.5 vol % CO₂;
c) introducing said feedstock and said gas into a mechanical agitation unit; and
d) subjecting the material of said feedstock to a mechanical agitation operation in the presence of said gas in said mechanical agitation unit.

The feedstock is preferably solid such that the invention provides a method for producing mechanochemically carbonated natural pozzolan, said method comprising the steps of:
a) providing a solid feedstock comprising or consisting of a natural pozzolan precursor;
b) providing a gas comprising CO₂, preferably comprising at least 0.5 vol % CO₂;
c) introducing said solid feedstock and said gas into a mechanical agitation unit; and
d) subjecting the material of said solid feedstock to a mechanical agitation operation in the presence of said gas in said mechanical agitation unit to obtain the mechanochemically carbonated natural pozzolan.

This method can be applied to various types of natural pozzolan precursors, advantageously resulting in unique mechanochemically carbonated natural pozzolan.

In another aspect, the invention provides a mechanochemically carbonated natural pozzolan obtainable by the method for producing the mechanochemically carbonated natural pozzolan described herein.

As will be shown in the appended examples, it was found that when such mechanochemically carbonated natural pozzolans described herein are used as a filler in cement the compressive strength of the resulting concrete is surprisingly increased beyond the values obtained for non-carbonated natural pozzolans and in particular well beyond the values of pure Portland cement. In particular, the set time for the strength development is strongly improved (shortened) compared to when non-mechanochemically carbonated natural pozzolan is used as a filler. Furthermore, a much higher amount of this mechanochemically carbonated natural pozzolan can be used as a filler while still resulting in acceptable or even improved concrete properties.

It was furthermore found that the durability of the concrete produced using said mechanochemically carbonated natural pozzolan is considerably increased. Without wishing to be bound by any theory, the present inventors believe that this is due to enhanced micro and sub-microscale hydration, a reduced chloride permeability, reduced porosity of the concrete and/or passivation of free lime. Moreover, the increased oxygen content as compared to untreated precursors or feedstock may result in better dispersion in polar solvents, and better compatibility with materials that have epoxy or carboxyl functional groups.

Furthermore, as is shown in the appended examples, the water demand is decreased compared to pure cement, as well as compared to cement filled with non-carbonated natural pozzolan. This is particularly surprising in view of the reduced particle size of the mechanochemically carbonated natural pozzolan compared to the non-carbonated natural pozzolan. A reduced particle size is generally associated with an increased water demand. The reduced water demand as compared to untreated feedstocks or pure cement may contribute to improved properties such as workability, compressive strength, permeability, watertightness, durability, weathering resistance, drying shrinkage and potential for cracking. For these reasons, limiting and controlling the amount of water in concrete is important for both constructability and service life. Thus, the present invention allows to have better control over the water demand. Without wishing to be bound by any theory, it is believed that the mechanochemical process of the invention may result in an increase in amorphous content when analyzed by XRD wherein at least some crystalline domains which may be present in a feedstock are maintained via an internal architecture in the form of microcrystallinity, which persists in a more generalized disordered structure. This disordered macro structure, thus, promotes higher reactivity and improves cement hydration.

Additionally, the production of the mechanochemically carbonated natural pozzolan relies on a cheap CO₂ capture technology platform capable of operating on dilute CO₂ streams, such as directly on a point source emissions of a combustion plant, such that a filler is provided which can be produced in an economically viable manner and which combines both the CO₂ emission reduction achieved by reduced cement production and the CO₂ emission reduction achieved by CO₂ sequestration. Thus, the mechanochemically carbonated natural pozzolan of the present invention, in particular the mechanochemically carbonated natural pozzolan of the invention, constitutes an excellent filler for many applications, combining distinct mechanical properties with a cost-efficient CO₂ capture technology.

In another aspect, the invention provides a composition comprising a mechanochemically carbonated natural pozzolan as described herein and a further material selected from the group consisting of asphalt, cement, geopolymers, polymers and combinations thereof.

In another aspect, the invention provides a method for preparing a composition as described herein, said method comprising the following steps:
(i) providing a mechanochemically carbonated natural pozzolan as described herein;
(ii) providing a further material selected from the group consisting of asphalt, cement, geopolymers, polymers and combinations thereof; and
(iii) combining the mechanochemically carbonated natural pozzolan of step (i) with the material of step (ii).

In another aspect, the invention provides a method for preparing concrete or mortar, said method comprising the following steps:
(i) providing a mechanochemically carbonated natural pozzolan as described herein and a further material which is selected from the group consisting of asphalt, cement, geopolymers, and combinations thereof, optionally in the form of the composition as described herein wherein the further material is selected from the group consisting of asphalt, cement, geopolymers, and combinations thereof;
(ii) providing a construction aggregate; and
(iii) contacting, preferably mixing the mechanochemically carbonated natural pozzolan and the further material of step (i) with the construction aggregate of step (ii) and optionally water.

In another aspect, the invention provides concrete obtainable by a method for preparing concrete described herein.

In another aspect the invention provides the use of a mechanochemically carbonated natural pozzolan as described herein:
as a filler, preferably as a filler in a material selected from the group consisting of asphalt, geopolymer, cement, mortar, polymers and combinations thereof;
as a partial replacement for asphalt, geopolymer or cement in concrete or mortar;
to increase the compressive strength of concrete or mortar;
to improve the durability of concrete or mortar;
to reduce the expansion of concrete;
to improve the durability of concrete or mortar by reducing chloride permeability and/or porosity;
to improve the strength activity index of concrete or mortar; and/or.
to reduce the water demand of concrete or mortar, preferably,
to concomitantly improve the strength activity index of concrete and reduce the water demand of concrete; or.
to concomitantly improve the strength activity index of mortar and reduce the water demand of mortar.

### DESCRIPTION OF THE EMBODIMENTS

The expression “comprise” and variations thereof, such as, “comprises” and “comprising” as used herein should be construed in an open, inclusive sense, meaning that the embodiment described includes the recited features, but that it does not exclude the presence of other features, as long as they do not render the embodiment unworkable.

The expressions “one embodiment”, “a particular embodiment”, “an embodiment” etc. as used herein should be construed to mean that a particular feature, structure or characteristic described in connection with the embodiment is included in at least one embodiment. Thus, the appearances of such expressions in various places throughout this specification do not necessarily all refer to the same embodiment. Furthermore, the particular features, structures, or characteristics may be combined in any suitable manner in one or more embodiments. For example, certain features of the disclosure which are described herein in the context of separate embodiments are also explicitly envisaged in combination in a single embodiment.

The singular forms “a,” “an,” and “the” as used herein should be construed to include plural referents unless the content clearly dictates otherwise. It should also be noted that the term “or” is generally employed in its broadest sense, that is as meaning “and/or” unless the content clearly dictates otherwise.

Whenever reference is made throughout this document to a compound which is a salt, this should be construed to include the anhydrous form as well as any solvates (in particular hydrates) of this compound.

The term “mechanochemically carbonated natural pozzolan” is used herein to refer to a natural pozzolan obtainable by the mechanochemical carbonation method of the present invention.

In accordance with the invention, the BET surface area as referred to herein is determined at a temperature of 77K using a sample mass of 0.1-0.5 g. The BET surface area as referred to herein is determined using nitrogen. A preferred analysis method to determine the BET surface area comprises heating samples to 400° C. for a desorption cycle prior to surface area analysis. A suitable and thus preferred analysis apparatus for determining the BET surface area is a Micromeritics Gemini VII 2390 Surface Analyzer preferably equipped with a Micromeritics FlowPrep 060 flowing-gas degassing unit.

TGA as used herein refers to Thermogravimetric Analysis, a technique known to the person skilled in the art. A preferred TGA setup to determine the CO₂ content of the feedstocks and carbonated materials in the context of the present invention is a Setaram TAG 16 TGA/DSC dual chamber balance employing a 0.1-2 mg sample. In accordance with the invention, the TGA is performed under an inert atmosphere, such as nitrogen or argon.

In accordance with the invention, the particle size distribution characteristics referred to herein such as D10, D50 and D90 as well as the specific surface area (unless explicitly mentioned to be BET surface area) are determined by measuring with a laser light scattering particle size analyzer utilizing the Fraunhofer theory of light scattering, such as the Brookhaven laser particle sizer, Model Microbrook 2000LD or another instrument of equal or better sensitivity and reporting the data using a volume equivalent sphere model. As is known to the skilled person, the D50 is the mass median diameter, i.e. the diameter at which 50% of a sample's mass is comprised of smaller particles. Similarly, the D10 and D90 represent the diameter at which 10 or 90% of a sample's mass is comprised of smaller particles.

The Total Carbon (TC) content referred to herein is preferably determined in accordance with the method described on Soil Sampling and Methods of Analysis, 2nd Ed., CRC Press (2008), p. 244 and further, incorporated herein by reference. The Total Carbon (TC) content is always expressed herein as wt. % based on the total weight of the composition being measured, i.e. based on the total weight of the clay precursor, or based on the total weight of the carbonated clay.

In accordance with the invention, the compressive strength, strength-activity index and water demand as referred to herein is determined in accordance with ASTM C311/C311M-22.

For the purposes of the present disclosure, ideal gas law is assumed such that the vol % of a gas is considered as equal to the mol %.

### Mechanochemically Carbonated Natural Pozzolan

In a first aspect the invention provides a mechanochemically carbonated natural pozzolan which preferably has a specific surface area within the range of 0.05-50 m²/g. The mechanochemically carbonated natural pozzolan material is obtainable by carbonation of a natural pozzolan precursor.

The mechanochemically carbonated natural pozzolan preferably has a CO₂ content of more than 0.5 wt. % (by total weight of the mechanochemically carbonated natural pozzolan), preferably more than 0.6 wt. % (by total weight of the mechanochemically carbonated natural pozzolan), more preferably more than 0.7 wt. % (by total weight of the mechanochemically carbonated natural pozzolan), wherein the CO₂ content is determined as the mass loss above 450° C. measured by TGA-MS employing a temperature trajectory wherein the temperature was increased from room temperature to 800° C. at a rate of 10° C./min and then decreased to room temperature at a rate of 10° C./min.

In preferred embodiments of the invention, the mechanochemically carbonated natural pozzolan meets the strength requirements set out in ASTM C618-12a (2012) and CSA A3001-18 (2018).

In embodiments of the invention, the mechanochemically carbonated natural pozzolan has a specific surface area of at least 0.2 m²/g, preferably at least 0.5 m²/g, more preferably at least 0.7 m²/g.

In preferred embodiments of the invention, the mechanochemically carbonated natural pozzolan has a specific surface area of less than 50 m²/g, preferably less than 30 m²/g, more preferably less than 10 m²/g. For example, the specific surface has a specific surface area of less than 50 m²/g, less than 48 m²/g, less than 46 m²/g, less than 44 m²/g, less than 42 m²/g, less than 40 m²/g, less than 38 m²/g, less than 36 m²/g, less than 34 m²/g, less than 32 m²/g, less than 30 m²/g, less than 28 m²/g, less than 26 m²/g, less than 24 m²/g, less than 22 m²/g, less than 20 m²/g, less than 18 m²/g, less than 16 m²/g, less than 14 m²/g, less than 12 m²/g, less than 10 m²/g, less than 8 m²/g, less than 6 m²/g, etc.

In highly preferred embodiments, the mechanochemically carbonated natural pozzolan has a specific surface area of less than 5 m²/g, preferably less than 3 m²/g, more preferably less than 2 m²/g. For example, the mechanochemically carbonated natural pozzolan may have a specific surface area of less than 5.0 m²/g, less than 4.5 m²/g, less than 4.0 m²/g, less than 3.5 m²/g, less than 3.0 m²/g, less than 2.5 m²/g, less than 2.0 m²/g, less than 1.5 m²/g, etc.

The inventors have observed that a mechanochemically carbonated natural pozzolan having a specific surface area within the ranges specified herein have particular properties when considering performance, handling, etc. in comparison to untreated precursors or even carbonated materials with other surface areas. Hence, in accordance with highly preferred embodiments of the invention, the mechanochemically carbonated natural pozzolan has a specific surface area of 0.2-50 m²/g, preferably 0.5-30 m²/g, more preferably 0.7-10 m²/g, such as a specific surface area in the range of 0.7-50 m²/g, preferably 0.7-30 m²/g, more preferably 0.7-10 m²/g; a specific surface area in the range of 0.7-5.0 m²/g, preferably 0.7-3.0 m²/g, more preferably 0.7-2.0 m²/g; a specific surface area in the range of 0.5-50 m²/g, preferably 0.5-30 m²/g, more preferably 0.5-10 m²/g; a specific surface area in the range of 0.5-5.0 m²/g, preferably 0.5-3.0 m²/g, more preferably 0.5-2.0 m²/g, etc.

In embodiments of the invention, the mechanochemically carbonated natural pozzolan has one, two, or three, preferably three, of the following characteristics:
a D10 within the range of 0.005-10 μm, preferably 0.01-5 μm, most preferably 0.1-3 μm;
a D50 within the range of 0.1-50 μm, preferably 0.5-35 μm, most preferably 1-15 μm;
a D90 within the range of 0.5-300 μm, preferably 1-300 μm, most preferably 15-300 μm.

In embodiments of the invention, the mechanochemically carbonated natural pozzolan described herein is provided which is obtainable by concomitant carbonation and size reduction of a natural pozzolan precursor wherein the ratio of the D50 of the carbonated natural pozzolan to the D50 of the natural pozzolan precursor is less than 0.5:1, preferably less than 0.1:1, more preferably less than 0.05:1. Preferably, the mechanochemically carbonated natural pozzolan is obtainable by carbonation of a natural pozzolan precursor wherein the ratio of the total carbon content of the mechanochemically carbonated natural pozzolan to the total carbon content of the natural pozzolan precursor is at least 1.5:1, preferably at least 2:1, more preferably at least 2.5:1. Similarly, the mechanochemically carbonated natural pozzolan is preferably obtainable by carbonation of a natural pozzolan precursor wherein the ratio of the CO₂ content of the mechanochemically carbonated natural pozzolan to the CO₂ content of the natural pozzolan precursor is at least 1.1:1, preferably at least 1.3:1, more preferably at least 1.4:1, wherein the CO₂ content is determined as the mass loss above 450° C. measured by TGA employing a temperature trajectory wherein the temperature was increased from room temperature to 800° C. at a rate of 10° C./min. The inventors have observed that methods wherein said ratio is at least 1.5:1, preferably at least 2:1, more preferably at least 2.5:1, provided even better results when the feedstock comprises volcanic ash, such that these are preferred when the feedstock comprises volcanic ash.

In embodiments of the invention, the mechanochemically carbonated natural pozzolan has a total carbon content of at least 0.1 wt. %, preferably at least 0.15 wt. %, more preferably at least 0.16 wt. %. The inventors have observed that a mechanochemically carbonated natural pozzolan (in particular a zeolite) having a total carbon content of at least 0.25 wt. %, preferably at least 0.3 wt. %, more preferably at least 0.35 wt. %, provided surprisingly large improvements in water demand. Hence, in preferred embodiments, the mechanochemically carbonated natural pozzolan has a total carbon content of at least 0.25 wt. %, preferably at least 0.3 wt. %, more preferably at least 0.35 wt. %, wherein the natural pozzolan is preferably a zeolite.

Without wishing to be bound by any theory, the present inventors believe that, in particular when the natural pozzolan is volcanic ash, the specific surface area increase effected by the dry mechanochemical carbonation method of another aspect of the invention (which is described herein elsewhere) is associated with the beneficial properties observed (such as the excellent strength activity index and reduced water demand). Hence, in embodiments of the invention, the mechanochemically carbonated natural pozzolan described herein is provided which is obtainable by concomitant carbonation and specific surface area increase of a natural pozzolan precursor wherein the ratio of the specific surface area of the mechanochemically carbonated natural pozzolan to the specific surface area of the natural pozzolan precursor is at least 1.2:1, preferably at least 1.4:1, more preferably at least 1.6:1. In highly preferred embodiments of the invention, the mechanochemically carbonated natural pozzolan described herein is provided which is obtainable by concomitant carbonation and specific surface area increase of a natural pozzolan precursor wherein the ratio of the specific surface area of the mechanochemically carbonated natural pozzolan to the specific surface area of the natural pozzolan precursor is at least 3.2:1, preferably at least 10:1, more preferably at least 20:1 and wherein preferably the natural pozzolan precursor is volcanic ash.

Without wishing to be bound by any theory, the present inventors believe that the BET surface area increase effected by the dry mechanochemical carbonation method of another aspect of the invention (which is described herein elsewhere) is associated with the beneficial properties observed (such as the excellent strength activity index, and reduced water demand). Hence, in embodiments of the invention, the mechanochemically carbonated natural pozzolan described herein is provided which is obtainable by concomitant carbonation and BET surface area increase of a natural pozzolan precursor wherein the ratio of the BET surface area of the mechanochemically carbonated natural pozzolan to the BET surface area of the natural pozzolan precursor is at least 2:1, preferably at least 5:1, more preferably at least 10:1.

Without wishing to be bound by any theory, the present inventors believe that the specific surface area increase effected by the dry mechanochemical carbonation method of another aspect of the invention (which is described herein elsewhere) may largely be attributed to an increase in the number of pores, observed by a decrease in the average pore width and an increase in the total pore surface area. Hence, in embodiments of the invention, the mechanochemically carbonated natural pozzolan is provided which is obtainable by concomitant carbonation and specific surface area increase of a natural pozzolan precursor wherein the BJH desorption cumulative surface area of pores of the mechanochemically carbonated natural pozzolan is at least 110%, preferably at least 120%, more preferably at least 150%, of the BJH desorption cumulative surface area of pores of the natural pozzolan precursor and the desorption average pore width (4V/A by BET) of the mechanochemically carbonated natural pozzolan is no more than 90%, preferably no more than 85%, more preferably no more than 80%, of the desorption average pore width (4V/A by BET) of the natural pozzolan precursor.

In accordance with the invention, the mechanochemically carbonated natural pozzolan has a strength activity index (SAI) at day 7 which is at least 75%, preferably at least 80%. The inventors have observed that the mechanochemical process of the present invention allows obtaining carbonated natural pozzolan having excellent day 7 SAI. Hence, in highly preferred embodiments the mechanochemically carbonated natural pozzolan has a SAI at day 7 which is at least 90%, preferably at least 98%, more preferably at least 120%.

In embodiments of the invention, the mechanochemically carbonated natural pozzolan has a strength activity index (SAI) at day 28 which is at least 75%, preferably at least 80%, more preferably at least 85%. The inventors have observed that the mechanochemical process of the present invention allows obtaining carbonated natural pozzolan having excellent day 28 SAI. Hence, in highly preferred embodiments the mechanochemically carbonated natural pozzolan has a SAI at day 28 which is at least 100%, preferably at least 105%, more preferably at least 120%.

In embodiments of the invention, the mechanochemically carbonated natural pozzolan has a water demand which is less than 98%, preferably less than 97.5%, more preferably less than 97%. The inventors have observed that the mechanochemical process of the present invention allows obtaining carbonated natural pozzolan having a water demand which is less than 94%, preferably less than 93%, more preferably less than 92%. In highly preferred embodiments the mechanochemically carbonated natural pozzolan has a water demand which is less than 91%, preferably less than 90%, more preferably less than 89%, wherein preferably the natural pozzolan is a zeolite.

The natural pozzolan is preferably selected from volcanic ash, volcanic rock, perlite, pumice, obsidian, scoria, tuffs (e.g. rhyolite tuffs, dacite tuffs, basaltic tuffs, trachytic tuffs, phonolitic tuffs, digenetic lithoid tuffs), andesite, clinoptiololite, heulandite, augite, apatite, titanite, biotite, hauynite, nosean, sodalite, magnetite, muscovite, chabazite, analcite, hematite, cristobalite, lecuite, kaolinite, illite, mica, hornblende, mordenite, andesites, basalt, diatomite, tripoli, cherts, opaline shales and zeolites, preferably selected from basalt, volcanic rock, perlite and zeolites.

In preferred embodiments of the invention, the natural pozzolan precursor comprises CaO and/or Ca(OH)₂, preferably the natural pozzolan precursor comprises at least 0.1 wt. % (by total weight of the natural pozzolan precursor) CaO and/or Ca(OH)₂, preferably at least 0.5 wt. % (by total weight of the natural pozzolan precursor) CaO and/or Ca(OH)₂.

### Method for the Production of Mechanochemically Carbonated Natural Pozzolan and Mechanochemically Carbonated Natural Pozzolan Obtainable Thereby

Without wishing to be bound by any theory, the present inventors believe that the dry mechanochemical carbonation method of the present invention imparts unique and desirable properties to the carbonated natural pozzolan obtainable by this method. For example, it is believed that the unique surface area and pore properties effected by the dry mechanochemical carbonation method of the present invention is important to achieve the surprising performance of the materials in e.g. concrete.

In a further aspect, the invention provides a method for producing a mechanochemically carbonated natural pozzolan, said method comprising the following steps:
a) providing a feedstock comprising or consisting of a natural pozzolan precursor;
b) providing a gas comprising CO₂, preferably at least 0.5 vol % CO₂;
c) introducing said feedstock and said gas into a mechanical agitation unit; and
d) subjecting the material of said feedstock to a mechanical agitation operation in the presence of said gas in said mechanical agitation unit to obtain the mechanochemically carbonated natural pozzolan.

The feedstock is preferably a solid feedstock such that the invention highly preferably provides a method for producing a mechanochemically carbonated natural pozzolan, said method comprising the following steps:
a) providing a solid feedstock comprising or consisting of a natural pozzolan precursor;
b) providing a gas comprising CO₂, preferably at least 0.5 vol % CO₂;
c) introducing said solid feedstock and said gas into a mechanical agitation unit; and
d) subjecting the material of said solid feedstock to a mechanical agitation operation in the presence of said gas in said mechanical agitation unit to obtain the mechanochemically carbonated natural pozzolan.

The natural pozzolan is preferably selected from volcanic ash, volcanic rock, perlite, pumice, obsidian, scoria, tuffs (e.g. rhyolite tuffs, dacite tuffs, basaltic tuffs, trachytic tuffs, phonolitic tuffs, digenetic lithoid tuffs), andesite, clinoptiololite, heulandite, augite, apatite, titanite, biotite, hauynite, nosean, sodalite, magnetite, muscovite, chabazite, analcite, hematite, cristobalite, lecuite, kaolinite, illite, mica, hornblende, mordenite, andesites, basalt, diatomite, tripoli, cherts, opaline shales and zeolites, preferably selected from basalt, volcanic rock, perlite and zeolites.

The natural pozzolan is preferably selected from volcanic ash, volcanic rock, perlite, pumice, obsidian, scoria, tuffs (e.g. rhyolite tuffs, dacite tuffs, basaltic tuffs, trachytic tuffs, phonolitic tuffs, digenetic lithoid tuffs), andesite, clinoptiololite, heulandite, augite, apatite, titanite, biotite, hauynite, nosean, sodalite, magnetite, muscovite, chabazite, analcite, hematite, cristobalite, lecuite, illite, mica, hornblende, mordenite, andesites, basalt, diatomite, tripoli, cherts, opaline shales and zeolites, preferably selected from basalt, volcanic rock, perlite and zeolites. The natural pozzolan is preferably selected from augite, volcanic ash, volcanic rock, augite, apatite, titanite, hauynite, and sodalite. These preferred natural pozzolans have been found to be exceptionally susceptible to carbonation, bringing significant performance benefits when considering the use as a supplementary cementitious material in concrete.

### Process Description

The term “feedstock” is to be interpreted as a material consisting of or comprising a natural pozzolan precursor. The natural pozzolan may be mixed with other materials (e.g. fly ash) to form the feedstock or it may consist essentially of natural pozzolan. The term “precursor” is used to designate the natural pozzolan before it is submitted to the mechanochemical carbonation of the invention. However, preferably, the feedstock consists essentially of a natural pozzolan precursor and optionally water, as this allows optimisation of process conditions to achieve the desired carbonated natural pozzolan properties without having to take into account the properties of other materials present in the feedstock.

It is within the capacity of one skilled in the art, in light of the guidance provided in the present disclosure, to adapt the relevant process parameters such that a mechanochemically carbonated natural pozzolan is obtained which has the properties recited herein.

The gas provided in step (b) may be any gas stream comprising CO₂, such as regular air, a waste gas stream having a low CO₂ concentration, or concentrated CO₂ streams.

In embodiments of the method described herein the gas provided in step (b) is regular air.

In highly preferred embodiments of the method described herein the gas provided in step (b) is a combustion flue gas, in particular a flue gas from fossil fuel combustion, wood pellet combustion, biomass combustion or municipal waste combustion. Fossil fuel combustion may be coal, petroleum, petroleum coke, natural gas, shale oil, bitumens, tar sand oil, or heavy oils combustion, or any combination thereof. The combustion flue gas may optionally have been treated to reduce the SO2 content, and/or the NOx content.

The CO₂ concentration in the gas provided in step (b) is preferably at least 0.1 vol %, more preferably at least 0.5 vol %. Typical CO₂ concentrations for combustion flue gas are in the range of 1-15 vol %, such as 2-10 vol %, such that it is preferred that the gas provided in step (b) has a CO₂ concentration in the range of 1-15 vol %, such as 2-10 vol %. In alternative embodiments of the invention, the gas provided in step (b) comprises at least 80 vol % CO₂, preferably at least 95 vol % CO₂. In some embodiments of the invention, the gas provided in step (b) comprises at least 80 vol % CO₂, preferably at least 95 vol % CO₂ and less than 1000 ppm (v/v) H₂O, preferably less than 100 ppm (v/v) H₂O. In some embodiments, the gas provided in step (b) comprises CO₂ in at least 0.1 vol % and H₂O in the range of 5-25 vol %. For example, in case of flue gas, the gas provided in step (b) preferably comprises CO₂ in the range of 1-15 vol %, such as 2-10 vol % and H₂O in the range of 5-25 vol %, such as 15-20 vol %. The gas is typically not in a supercritical state as this is not necessary for the mild mechanochemical carbonation process of the present invention. Hence in any embodiment of the invention, it is highly preferred that the gas is not in a supercritical state.

In some embodiments of the invention, the method described herein is provided with the proviso that the temperature and pressure during step (d) are such that the pressure is lower than the saturated vapour pressure of water at the temperature in the mechanical agitation unit.

The expression “in the presence of said gas” in step (d) should be construed to mean that the atmosphere inside the mechanical agitation unit consists essentially of the gas provided in step (b) when step (d) is initiated. It will be understood by the skilled person that the composition of the gas will change as the reaction progresses unless the reactor (the mechanical agitation unit) is continuously purged or replenished.

In general, step (d) can be performed at atmospheric pressure, below atmospheric pressure or above atmospheric pressure. In general it is preferred that step (d) is performed at or above atmospheric pressure. Hence, it is preferred that step (d) is performed at a pressure of at least about 100 kPa (e.g. at least 101.325 kPa). In preferred embodiments of the invention, step (d) is performed at a pressure of more than around 300 kPa (e.g., 303.975 kPa), preferably more than around 600 kPa (e.g., 607.95 kPa). In alternative embodiments of the invention, step (d) is performed at pressures of less than around 100 kPa (e.g. at least 101.325 kPa), such as less than 50 kPa or less than 10 kPa. It will be understood by the skilled person that (if not actively maintained) the pressure of the gas will change as the reaction progresses. In these embodiments it should be understood that the pressure inside the mechanical agitation unit is as specified herein when step (d) is initiated. In some embodiments the pressure inside the mechanical agitation unit is as specified herein throughout step (d).

In highly preferred embodiments of the method described herein, step (d) is performed at pressures below the critical pressure of carbon dioxide. Furthermore, the inventors have found that very high pressures are not required to prepare the carbonated glassy solid of the present invention such that the method can be performed in a very energy-efficient manner. Hence, it is preferred that step (d) is performed at pressures less than 10000 kPa, preferably less than 5000 kPa, more preferably less than 2500 kPa and most preferably less than 1000 kPa. It will be understood by the skilled person that (if not actively maintained) the pressure of the gas will change as the reaction progresses. In these embodiments, it should be understood that the pressure inside the mechanical agitation unit is as specified herein at at least one point in time during step (d), for example when step (d) is initiated. In some embodiments, the pressure inside the mechanical agitation unit is as specified herein throughout most or substantially all of step (d).

In embodiments of the invention, step (d) is performed for at least 1 minute, preferably at least 30 minutes, such as at least 1 hour, at least 4 hours, or at least 8 hours.

In preferred embodiments of the invention, step (d) is substantially free of CO₂ solubilizers such as glycerin (propane-1,2,3-triol). Such CO₂ solubilizing agents act to enhance the solubility of carbon dioxide in an aqueous solution and allow the formation of carbonic acid concentration for sequestering carbon dioxide.

In highly preferred embodiments of the method described herein, in order to stimulate carbonation, step (d) is performed at a temperature of less than 150° C., preferably less than 100° C., preferably less than 90° C., more preferably less than 80° C., most preferably less than 75° C. In highly preferred embodiments of the invention, step (d) is performed at a temperature within the range of 45-85° C., preferably 55-70° C. In preferred embodiments of the invention, no active heating is applied and any increase in temperature is attributed to friction resulting from the mechanical agitation or to exothermic reactions taking place during the mechanochemical carbonation. The temperature is preferably determined on the solid material in the reactor (i.e. the mechanical agitation unit) during processing.

The low temperature requirement of the present process means that no fossil fuels are required, and electric heating means (or low caloric value green fuel sources) can realistically be used to supply heat in case friction caused by the mechanical agitation is insufficient to reach the desired temperature, such as more than 45° C. In this way, fossil fuels can be avoided throughout the whole production chain.

As with any chemical process, the appropriate reaction time is highly dependent on the extent of carbonation desired, the surface area desired, as well as the pressure, temperature and mechanochemical agitation applied and can easily be determined by sampling material on a regular basis and monitoring reaction progress e.g. via BET analysis, particle size analysis, specific surface area and Total Carbon determination as explained herein.

The present inventors have furthermore found that the mechanochemical carbonation methods described herein may advantageously be performed without employing additional oxidizing agents such as acids. Hence, the mechanochemical carbonation methods described herein are preferably performed without employing a strong acid, preferably without employing any further oxidizing agent other than the gas provided in step (b).

In preferred embodiments of the invention, the mechanical agitation operation of step (d) comprises grinding, milling, mixing, stirring (such as low-speed stirring or high-speed stirring), shearing (such as high-torque shearing), shaking, blending, pulverizing, powderizing, crushing, crumbling, a fluidized bed or ultrasonication, preferably grinding, milling, mixing, stirring (such as low-speed stirring or high-speed stirring), shearing (such as high-torque shearing), or ultrasonication. The present inventors have found that the mechanochemical carbonation process is facilitated if the mechanochemical agitation operation of step (d) the mechanochemical agitation operation of step (d) is performed in the presence of grinding or milling media, preferably balls or beads. A preferred material is stainless steel or aluminium oxide. In such highly preferred embodiments, the mechanical agitation operation may be simply rotating the mechanical agitation unit containing the solid feedstock, the grinding or milling media, and the gas. For example, grinding or milling media can be made from steel (e.g. AISI H13, modified H10), aluminium oxide, chrome white cast irons (e.g. ASTM A532), molybdenum steel (e.g. AISI M2, M4, M-42), chromium-based steels (e.g. H11, H12, H13 CPM V9, ZDP-189) or other media with a target HRC hardness of 60. Such grinding media can be utilized with or without surface treatments such as nitriding and carburizing. This can conveniently be performed in a rotating drum. It will be understood that the product obtainable by the process of the invention when performed in a rotating drum, may also be obtainable using alternative grinding or milling techniques known to the skilled person.

In preferred embodiments of the invention, step (d) is performed in the presence of a catalyst, preferably a metal oxide catalyst, such as a transition metal oxide catalyst. Examples of suitable catalysts are selected from the group consisting of iron oxides, cobalt oxides, ruthenium oxides, titanium oxides, nickel oxides, aluminium oxides and combinations thereof.

Hence, as will be understood from the above, in highly preferred embodiments of the invention, step (d) comprises grinding, milling, mixing, stirring (such as low-speed stirring or high-speed stirring), shearing (such as high-torque shearing), shaking, blending, pulverizing, powderizing, crushing, crumbling, a fluidized bed or ultrasonication, preferably grinding, milling, mixing, stirring (such as low-speed stirring or high-speed stirring), shearing (such as high-torque shearing), or ultrasonication, in the presence of grinding or milling media and a metal oxide catalyst.

The present inventors have found that it is advantageous with a view to the efficiency of the mechanochemical carbonation (e.g. reaction time, CO₂ absorption and particle size reduction) to employ media as described herein before comprising (e.g. coated with) said metal oxide catalyst and/or to employ a mechanical agitation unit (or parts thereof) which comprises (or is coated with) said metal oxide catalyst, for example on one or more surfaces contacting the feedstock during step (d). As explained herein elsewhere, the mechanical agitation operation may be simply rotating the mechanical agitation unit containing the feedstock or the natural pozzolan precursor for mechanochemical carbonation, the grinding or milling media, the metal oxide catalyst and the gas. This can conveniently be performed in a rotating drum.

As will be clear from the present description, in highly preferred embodiments, step (d) is a substantially dry process. While some moisture may be present and is beneficial for carbonation efficiency, step (d) is highly preferably not performed on an aqueous solution or slurry. The present inventors have found that performing step (d) on a solid greatly improves energy efficiency (as no water has to be removed afterwards) and imparts unique properties on the resulting mechanochemically carbonated natural pozzolans, yielding materials which are substantially different from e.g. aqueous carbonation materials. This is also reflected in their distinct properties, e.g. when used as a filler in concrete. In embodiments of the invention, the solid feedstock preferably has a moisture content of less than 30 wt. % (by total weight of the solid feedstock), preferably less than 20 wt. %.

In accordance with highly preferred embodiments of the invention, the feedstock provided in step (a) is a solid feedstock. The solid feedstock provided in step (a) highly preferably has a moisture content of less than 30 wt. % (by total weight of the solid feedstock), preferably less than 20 wt. %, more preferably less than 15 wt. %. With a view to carbonation efficiency, the solid feedstock preferably has a moisture content of at least 2 wt. % (by total weight of the solid feedstock), preferably at least 5 wt. %, more preferably at least 10 wt. %. At moisture contents of less than 30 wt. % (by total weight of the solid feedstock), the feedstock still is and behaves like a solid. In some embodiments of the invention the solid feedstock may have a moisture content of less than 10 wt. % (by total weight of the solid feedstock), less than 5 wt. %, or less than 2 wt. %. The solid feedstock preferably has the moisture content specified herein at at least one point in time during step (d), for example when step (d) is initiated. In some embodiments, the moisture content of the feedstock is as specified herein throughout a majority or substantially all of step (d).

It is within the routine capabilities of the skilled person to adjust the moisture content of the feedstock based on the guidance provided herein, for example by spraying spraying the solid feedstock with an aqueous composition such as water before and/or during step (d).

In other embodiments, the feedstock provided in step (a) is an aqueous slurry, solution or suspension, for example an aqueous slurry. The aqueous slurry, solution or suspension feedstock provided in step (a) may have a water content of more than 50 wt. % (by total weight of the aqueous slurry, solution or suspension feedstock), for example more than 70 wt. %. The aqueous slurry, solution or suspension feedstock preferably has the water content specified herein at at least one point in time during step (d), for example when step (d) is initiated. In some embodiments, the water content of the aqueous slurry, solution or suspension feedstock is as specified herein throughout a majority or substantially all of step (d).

In some embodiments, step (d) is followed by a dewatering step to reduce the water content of the obtained mechanochemically carbonated natural pozzolan.

In particular, the present inventors have found that it is important that step (d) is carried out such that certain extents of carbonation, size reduction and/or surface area increase are effect during step (d), i.e. during the combined carbonation and mechanical agitation. This results in markedly different materials from materials which were e.g. milled and subsequently carbonated. To obtain these effects it is preferred that step (a) of the method comprises providing a solid feedstock as described herein earlier, and that step (d) is performed on the solid feedstock provided in step (a).

Thus, in highly preferred embodiments, the method of the invention is provided wherein carbonation, size reduction and/or surface area increase are effected during step (d) such that
the ratio of the total carbon content of the mechanochemically carbonated natural pozzolan obtained in step (d) to the total carbon content of the natural pozzolan precursor of step (a) is at least 1.5:1, preferably at least 2:1, more preferably at least 2.5:1;
and preferably, the ratio of the CO₂ content of the mechanochemically carbonated natural pozzolan obtained in step (d) to the CO₂ content of the natural pozzolan precursor of step (a) is at least 1.1:1, preferably at least 1.3:1, more preferably at least 1.4:1, wherein the CO₂ content is determined as the mass loss above 450° C. measured by TGA employing a temperature trajectory wherein the temperature was increased from room temperature to 800° C. at a rate of 10° C./min.

As is shown in the examples, certain materials have additional improved strength and/or water demand characteristics. Hence, in some particularly preferred embodiments of the invention, the method of the invention is provided wherein carbonation, size reduction and/or surface area increase are effected during step (d) such that the method has one, two, or all three, preferably all three, of the following characteristics
the ratio of the CO₂ content of the mechanochemically carbonated natural pozzolan obtained in step (d) to the CO₂ content of the natural pozzolan precursor of step (a) is at least 1.5:1, preferably at least 2:1, more preferably at least 2.5:1, wherein the CO₂ content is determined as the mass loss above 450° C. measured by TGA employing a temperature trajectory wherein the temperature was increased from room temperature to 800° C. at a rate of 10° C./min;
the ratio of the D50 of the mechanochemically carbonated natural pozzolan obtained in step (d) to the D50 of the natural pozzolan precursor of step (a) is less than 0.8:1, preferably less than 0.75:1, more preferably less than 0.5:1;
the ratio of the specific surface area of the mechanochemically carbonated natural pozzolan obtained in step (d) to the specific surface area of the natural pozzolan precursor of step (a) is at least 2:1, preferably at least 3:1, more preferably at least 10:1;
and wherein preferably the natural pozzolan precursor is volcanic ash.

The skilled person will understand that, as the material of step (a) is fed to step (d), this means that the carbonation, size reduction and/or surface area specified above is effected during step (d).

Without wishing to be bound by any theory, the present inventors believe that the BET surface area increase effected by the dry mechanochemical carbonation method is associated with the beneficial properties observed (such as the excellent strength activity index, and reduced water demand). Hence, in highly preferred embodiments of the invention, the method of the invention is provided wherein carbonation and BET surface area increase are effected during step (d) such that the ratio of the BET surface area of the mechanochemically carbonated natural pozzolan to the BET surface area of the natural pozzolan precursor is at least 2:1, preferably at least 5:1, more preferably at least 10:1.

In particularly preferred embodiments of the method of the invention, the BJH desorption cumulative surface area of pores of the mechanochemically carbonated natural pozzolan obtained in step (d) is at least 110%, preferably at least 120%, more preferably at least 150%, of the BJH desorption cumulative surface area of pores of the natural pozzolan precursor and the desorption average pore width (4V/A by BET) of the mechanochemically carbonated natural pozzolan obtained in step (d) is no more than 90%, preferably no more than 85%, more preferably no more than 80%, of the desorption average pore width (4V/A by BET) of the natural pozzolan precursor.

In embodiments of the invention, the method described herein does not comprise a solid-liquid separation step selected from filtration, decantation, and gravitational separation (e.g. using cyclones) after step (d), preferably the method of the invention does not comprise any solid-liquid separation step after step (d).

In embodiments of the invention, the method described herein does not comprise a size-selection step such as a screening or sieving step, after step (d).

### Properties of the Natural Pozzolan Precursor Used in the Mechanochemical Carbonation Method of the Present Invention

In preferred embodiments of the method described herein, the natural pozzolan precursor is a particulate solid material which has a specific surface area of less than 20 m²/g, preferably less than 10 m²/g, more preferably less than 2 m²/g.

In highly preferred embodiments of the invention, the natural pozzolan precursor has one, two, or three, preferably three, of the following characteristics:
a D10 within the range of 0.1-100 μm, preferably 0.1-75 μm, most preferably 0.1-50 μm;
a D50 within the range of 5-200 μm, preferably 10-200 μm, most preferably 10-150 μm;
a D90 within the range of 10-750 μm, preferably 20-500 μm, most preferably 40-300 μm.

In preferred embodiments, the natural pozzolan precursor is selected from intermediate (comprising 52-66 wt % SiO₂), acidic (comprising >66 wt % SiO₂), basic (comprising 45-52 wt % SiO₂) or ultrabasic (comprising <45 wt % SiO₂) natural pozzolans.

Without wishing to be bound by any theory, it is believed that the presence of at least some alkaline earth metal oxides or hydroxides facilitates carbonation. Hence, according to embodiments or preferred embodiments of the invention, the natural pozzolan precursor, as described herein, has a total of alkaline earth metal oxides and hydroxides of at least 0.01 wt. %, preferably at least 0.05 wt. %. In preferred embodiments of the invention, the natural pozzolan precursor provided in step (a) comprises CaO and/or Ca(OH)₂, preferably the natural pozzolan precursor comprises at least 0.1 wt. % (by total weight of the natural pozzolan precursor) CaO and/or Ca(OH)₂, preferably at least 0.5 wt. % (by total weight of the natural pozzolan precursor) CaO and/or Ca(OH)₂.

### Properties of the Mechanochemically Carbonated Natural Pozzolan Obtained in Step (d)

In preferred embodiments of the method for producing a mechanochemically carbonated natural pozzolan described herein, the carbonated natural pozzolan obtained in step (d) has a specific surface area within the range of 0.05-50 m²/g. The mechanochemically carbonated natural pozzolan obtained in step (d) preferably has a CO₂ content of more than 0.5 wt. % (by total weight of the mechanochemically carbonated natural pozzolan), preferably more than 0.6 wt. % (by total weight of the mechanochemically carbonated natural pozzolan), more preferably more than 0.7 wt. % (by total weight of the mechanochemically carbonated natural pozzolan), wherein the CO₂ content is determined as the mass loss above 450° C. measured by TGA-MS employing a temperature trajectory wherein the temperature was increased from room temperature to 800° C. at a rate of 10° C./min and then decreased to room temperature at a rate of 10° C./min.

In preferred embodiments of the method for producing a mechanochemically carbonated natural pozzolan described herein, the carbonated natural pozzolan obtained in step (d) has a specific surface area within the range of 0.05-50 m²/g. The mechanochemically carbonated natural pozzolan obtained in step (d) preferably has a CO₂ content of more than 1 wt. % (by total weight of the mechanochemically carbonated natural pozzolan), preferably more than 2 wt. % (by total weight of the mechanochemically carbonated natural pozzolan), more preferably more than 3 wt. % (by total weight of the mechanochemically carbonated natural pozzolan), wherein the CO₂ content is determined as the mass loss above 450° C. measured by TGA-MS employing a temperature trajectory wherein the temperature was increased from room temperature to 800° C. at a rate of 10° C./min and then decreased to room temperature at a rate of 10° C./min.

In preferred embodiments of the invention, the carbonated natural pozzolan obtained in step (d) meets the strength requirements set out in ASTM C618-12a (2012) and CSA A3001-18 (2018). In particular embodiments, the method described herein does not comprise a size-selection step, such as a screening or sieving step, after step (d) and the carbonated natural pozzolan obtained in step (d) meets the strength requirements set out in ASTM C618-12a (2012) and CSA A3001-18 (2018).

In embodiments of the invention, the mechanochemically carbonated natural pozzolan obtained in step (d) has a specific surface area of at least 0.2 m²/g, preferably at least 0.5 m²/g, more preferably at least 0.7 m²/g.

In preferred embodiments of the invention, the carbonated natural pozzolan obtained in step (d) has a specific surface area of less than 50 m²/g, preferably less than 30 m²/g, more preferably less than 10 m²/g. For example, the mechanochemically carbonated natural pozzolan obtained in step (d) has a specific surface area of less than 50 m²/g, less than 48 m²/g, less than 46 m²/g, less than 44 m²/g, less than 42 m²/g, less than 40 m²/g, less than 38 m²/g, less than 36 m²/g, less than 34 m²/g, less than 32 m²/g, less than 30 m²/g, less than 28 m²/g, less than 26 m²/g, less than 24 m²/g, less than 22 m²/g, less than 20 m²/g, less than 18 m²/g, less than 16 m²/g, less than 14 m²/g, less than 12 m²/g, less than 10 m²/g, less than 8 m²/g, less than 6 m²/g, etc.

In highly preferred embodiments, the carbonated natural pozzolan obtained in step (d) has a specific surface area of less than 5 m²/g, preferably less than 3 m²/g, more preferably less than 2 m²/g. For example, the mechanochemically carbonated natural pozzolan may have a specific surface area of less than 5.0 m²/g, less than 4.5 m²/g, less than 4.0 m²/g, less than 3.5 m²/g, less than 3.0 m²/g, less than 2.5 m²/g, less than 2.0 m²/g, less than 1.5 m²/g, etc.

The inventors have observed that a mechanochemically carbonated natural pozzolan having a specific surface area within the ranges specified herein have particular properties when considering performance, handling, etc. in comparison to untreated precursors or even carbonated materials with other surface areas. Hence, in accordance with highly preferred embodiments of the invention, the mechanochemically carbonated natural pozzolan obtained in step (d) has a specific surface area of 0.2-50 m²/g, preferably 0.5-30 m²/g, more preferably 0.7-10 m²/g, such as a specific surface area in the range of 0.7-50 m²/g, preferably 0.7-30 m²/g, more preferably 0.7-10 m²/g; a specific surface area in the range of 0.7-5.0 m²/g, preferably 0.7-3.0 m²/g, more preferably 0.7-2.0 m²/g; a specific surface area in the range of 0.5-50 m²/g, preferably 0.5-30 m²/g, more preferably 0.5-10 m²/g; a specific surface area in the range of 0.5-5.0 m²/g, preferably 0.5-3.0 m²/g, more preferably 0.5-2.0 m²/g, etc.

In embodiments of the invention, the carbonated natural pozzolan obtained in step (d) has one, two, or three, preferably three, of the following characteristics:
a D10 within the range of 0.005-10 μm, preferably 0.01-5 μm, most preferably 0.1-3 μm;
a D50 within the range of 0.1-50 μm, preferably 0.5-35 μm, most preferably 1-15 μm;
a D90 within the range of 0.5-300 μm, preferably 1-300 μm, most preferably 15-300 μm.

In embodiments of the invention, the mechanochemically carbonated natural pozzolan obtained in step (d) has a total carbon content of at least 0.1 wt. %, preferably at least 0.15 wt. %, more preferably at least 0.16 wt. %. The inventors have observed that a mechanochemically carbonated natural pozzolan (in particular a zeolite) having a total carbon content of at least 0.25 wt. %, preferably at least 0.3 wt. %, more preferably at least 0.35 wt. %, provided surprisingly large improvements in water demand. Hence, in preferred embodiments, the mechanochemically carbonated natural pozzolan obtained in step (d) has a total carbon content of at least 0.25 wt. %, preferably at least 0.3 wt. %, more preferably at least 0.35 wt. %, provided even better results, wherein the mechanochemically carbonated natural pozzolan is preferably a zeolite.

In accordance with the invention, the mechanochemically carbonated natural pozzolan obtained in step (d) has a strength activity index (SAI) at day 7 which is at least 75%, preferably at least 80%. The inventors have observed that the mechanochemical process of the present invention allows obtaining carbonated natural pozzolan having excellent day 7 SAI. Hence, in highly preferred embodiments the mechanochemically carbonated natural pozzolan obtained in step (d) has a SAI at day 7 which is at least 90%, preferably at least 98%, more preferably at least 120%.

In embodiments of the invention, the mechanochemically carbonated natural pozzolan obtained in step (d) has a strength activity index (SAI) at day 28 which is at least 75%, preferably at least 80%, more preferably at least 85%. The inventors have observed that the mechanochemical process of the present invention allows obtaining carbonated natural pozzolan having excellent day 28 SAI. Hence, in highly preferred embodiments the mechanochemically carbonated natural pozzolan obtained in step (d) has a SAI at day 28 which is at least 100%, preferably at least 105%, more preferably at least 120%.

In embodiments of the invention, the mechanochemically carbonated natural pozzolan obtained in step (d) has a water demand which is less than 98%, preferably less than 97.5%, more preferably less than 97%. The inventors have observed that the mechanochemical process of the present invention allows obtaining carbonated natural pozzolan having a water demand which is less than 94%, preferably less than 93%, more preferably less than 92%. In highly preferred embodiments the mechanochemically carbonated natural pozzolan obtained in step (d) has a water demand which is less than 91%, preferably less than 90%, more preferably less than 89%, wherein preferably the natural pozzolan is a zeolite.

### The Mechanochemically Carbonated Natural Pozzolan Obtainable by the Method Described Herein

The present inventors have found that the mechanochemical carbonation described herein imparts unique properties on the resulting mechanochemically carbonated natural pozzolans, yielding materials which are substantially different from e.g. aqueous carbonation materials. This is also reflected in their distinct properties, e.g. when used as a filler in concrete. In particular, the present inventors have found that it is important that step (d) is carried out such that certain extents of carbonation, size reduction and/or surface area increase are effect during step (d), i.e. during the combined carbonation and mechanical agitation. This results in markedly different materials from materials which were e.g. carbonated in an aqueous environment, or even materials which were milled and subsequently carbonated.

Hence, in another aspect the invention provides the mechanochemically carbonated natural pozzolan obtainable by the method for producing mechanochemically carbonated natural pozzolan described herein.

As will be understood by the skilled person in light of the present disclosure, the mechanochemically carbonated natural pozzolan of the present invention constitutes an excellent filler for many applications, combining distinct mechanical properties with a cost-efficient CO₂ sequestration approach.

### Composition Comprising a Mechanochemically Carbonated Natural Pozzolan, and Method for the Preparation Thereof

Hence, in another aspect the invention provides a composition comprising a mechanochemically carbonated natural pozzolan as described herein and a further material selected from the group consisting of asphalt, cement, geopolymers, polymers, and combinations thereof, preferably cement, more preferably Portland cement.

In embodiments, the further material is a polymer selected from thermoplastic polymers and thermosetting polymers. In preferred embodiments, the further component is a polymer selected from the group consisting of epoxide resin, phenol-formaldehyde resin, polyalkylene terephthalate (preferably polyethylene terephthalate), polalkylene adipate terephthalate (preferably polybutylene adipate terephthalate), polyalkylene isosorbide terephthalate (preferably polyethylene isosorbide terephthalate), polyalkylene aromatic polyamide (preferably polyethylene aromatic polyamide), polyacrylonitrile, polyacetal, polyimide, aromatic polyester, polyisoprene (preferably cis-1,4-polyisoprene), polyethylene, polypropylene, polyurethane, polyisocyanurate, polyamide, polyether, polyester, polyhydroxyalkanoate, polylactic acid, poly lactic-co-glycolic acid, polyvinylidene fluoride, polyvinyl acetate, polyvinyl chloride, polystyrene, polytetrafluoroethylene, acrylonitrile-butadiene-styrene, nitrile rubber, styrenebutadiene, ethylene-vinyl acetate, copolymers thereof and combinations thereof, more preferably a polyolefin, such as polypropylene, polyethylene, copolymers thereof and combinations thereof. The term “polymer” as used herein includes copolymers, such as block copolymers.

In highly preferred embodiments the further material is selected from cement, asphalt, geopolymers or combinations thereof.

In accordance with the invention, the cement may be a hydraulic or non-hydraulic cement. In preferred embodiments, the cement is a hydraulic cement, such as Portland cement. In highly preferred embodiments of the invention, the cement is one of the cements defined in EN197-1 (2011), preferably Portland cement as defined in EN197-1 (2011).

In embodiments of the invention, the composition comprises more than 0.1 wt. % (by total weight of the composition), preferably more than 1 wt. %, more preferably more than 5 wt. % of the mechanochemically carbonated natural pozzolan and/or more than 0.1 wt. % (by total weight of the composition), preferably more than 1 wt. %, more preferably more than 20 wt. % of the further material.

In embodiments of the invention, the composition comprises less than 60 wt. % (by total weight of the composition), preferably less than 50 wt. %, more preferably less than 45 wt. % of the mechanochemically carbonated natural pozzolan and/or less than 95 wt. % (by total weight of the composition), preferably less than 90 wt. %, more preferably less than 80 wt. % of the further material.

In embodiments of the invention, the composition is provided wherein the weight:weight ratio of the mechanochemically carbonated natural pozzolan to the further material is within the range of 1:9 to 2:1, preferably within the range of 1:8 to 1:1, more preferably within the range of 1:6 to 5:6.

In embodiments of the invention, the composition comprises 5-70 wt. % (by total weight of the composition), preferably 10-60 wt. %, more preferably 20-50 wt. % of the mechanochemically carbonated natural pozzolan and 30-95 wt. % (by total weight of the composition), preferably 40-90 wt. %, preferably 50-80 wt. % of the further material.

In embodiments of the invention, the composition comprises less than 5 wt. % (by total weight of the composition water, preferably less than 1 wt. %, more preferably less than 0.1 wt. %. The amount of water can suitably be determined as the mass loss up to 120° C. measured by TGAMS employing a temperature trajectory wherein the temperature was increased from room temperature to 800° C. at a rate of 10° C./min.

In embodiments of the invention, the composition consists of the mechanochemically carbonated natural pozzolan and the further material.

In another aspect the invention provides a method for preparing a composition as described herein, said method comprising the following steps:
(i) providing a mechanochemically carbonated natural pozzolan as described herein, preferably a mechanochemically carbonated natural pozzolan as described herein;
(ii) providing a further material selected from the group consisting of asphalt, cement, geopolymers, polymers and combinations thereof;
(iii) combining the mechanochemically carbonated natural pozzolan solid of step (i) with the material of step (ii).

### A Method for Preparing Concrete or Mortar

Hence, in another aspect the invention provides a method for preparing concrete or mortar, said method comprising the following steps:
(i) providing a mechanochemically carbonated natural pozzolan as described herein and a further material which is selected from the group consisting of asphalt, cement, geopolymers, and combinations thereof, optionally in the form of the composition as described herein wherein the further material is selected from the group consisting of asphalt, cement, geopolymers, and combinations thereof;
(ii) providing a construction aggregate;
(iii) contacting, preferably mixing the mechanochemically carbonated natural pozzolan and the further material of step (i) with the construction aggregate of step (ii) and optionally water.

In preferred embodiments of the invention, step (iii) further comprises contacting, preferably mixing the mechanochemically carbonated natural pozzolan and the further material of step (i) with the construction aggregate of step (ii) and water. In accordance with the invention, the mechanochemically carbonated natural pozzolan and the further material of step (i), the construction aggregate of step (ii) and the water may be contacted, preferably mixed at substantially the same time, or in a step-wise manner wherein the composition of step (i) is first contacted, preferably mixed with water, before being contacted, preferably mixed with the construction aggregate of step (ii).

In another aspect the invention provides a concrete or mortar obtainable by the method for preparing concrete or mortar as described herein.

In another aspect the invention provides the use of a mechanochemically carbonated natural pozzolan as described herein:
as a filler, preferably as a filler in a material selected from the group consisting of asphalt, cement, geopolymers, mortar, polymers and combinations thereof;
as a partial replacement for asphalt, geopolymer or cement in concrete or mortar;
to increase the compressive strength of concrete or mortar;
to improve the durability of concrete or mortar;
to reduce the expansion of concrete;
to improve the durability of concrete or mortar by reducing chloride permeability and/or porosity;
to improve the strength activity index of concrete or mortar; and/or
to reduce the water demand of concrete or mortar, preferably,
to concomitantly improve the strength activity index of concrete and reduce the water demand of concrete; or
to concomitantly improve the strength activity index of mortar and reduce the water demand of mortar.

### EXAMPLES

Particle Size Distribution and specific surface area measurements were carried out on a Brookhaven laser particle sizer, Model Microbrook 2000LD using utilizing the Fraunhofer theory of light scattering and reporting the data using a volume equivalent sphere model.

Compressive strength, strength activity index and water demand was measured in accordance with ASTM C311/C311M-22.

The CO₂ content was determined as the mass loss above 450° C. as measured by TGA employing a temperature trajectory wherein the temperature was increased from room temperature to 800° C. at a rate of 10° C./min. employing a Setaram TAG 16 TGA/DSC dual chamber balance loaded with a 0.1-2 mg sample under an inert nitrogen atmosphere.

Total carbon content was determined in accordance with the method described on Soil Sampling and Methods of Analysis, 2^{nd} Ed., CRC Press (2008), pg. 244 and further.

The pozzolan precursors obtained from the suppliers, were subjected to a conventional grinding mill before being used in the mechanochemical process.

### Example 1

### Sample A

Mechanochemically carbonated natural pozzolans were produced by inserting 5 kg of natural pozzolan precursor (a zeolite) which was pretreated by conventional milling into a pressure cell with 150 kg of milling media (ceramic ball bearings of 10 mm size). The cell is pressurized with flue gas (CO₂:8-10 vol %; H₂O: 18-20 vol %; O₂:2-3 vol %; N₂:67-72 vol %) to an initial pressure of 448 kPa, and rotated on rollers at 38 RPM for 4 days to obtain mechanochemically carbonated natural pozzolan. The reaction was initiated at room temperature and no heating or cooling was applied. The ceramic bearings have an Al₂O₃ content of 92 wt. % such that they also served as catalyst. The properties of the milled natural pozzolan precursor (A1) and the obtained mechanochemically carbonated natural pozzolan (A2) are shown in the below table.

### Sample B

Mechanochemically carbonated natural pozzolans were produced by inserting 10 kg of natural pozzolan precursor (a perlite) into a pressure cell with 150 kg of milling media (ceramic ball bearings of 10 mm size). The cell is pressurized with flue gas (CO₂:8-10 vol %; H₂O: 18-20 vol %; O₂:2-3 vol %; N₂:67-72 vol %) to an initial pressure of 448 kPa, and rotated on rollers at 38 RPM for 2 days to obtain mechanochemically carbonated natural pozzolan. The material was used as received. The reaction was initiated at room temperature and no heating or cooling was applied. The ceramic bearings have an Al₂O₃ content of 92 wt. % such that they also served as catalyst. A portion of the natural pozzolan precursor was subjected to conventional milling to serve as a comparative example. The properties of the milled natural pozzolan comparative (B1) and the obtained mechanochemically carbonated natural pozzolan (B2) are shown in the below table.

### Samples C

Mechanochemically carbonated natural pozzolans were produced by inserting 10 kg of natural pozzolan precursor (volcanic ash) into a pressure cell with 100 kg of milling media (ceramic ball bearings of 25.4 mm size). The cell is pressurized with flue gas (CO₂:8-10 vol %; H₂O: 18-20 vol %; O₂:2-3 vol %; N₂:67-72 vol %) to an initial pressure of 448 kPa, and rotated on rollers at 38 RPM for 2 days to obtain mechanochemically carbonated natural pozzolan. The material was used as received. The reaction was initiated at room temperature and no heating or cooling was applied. The ceramic bearings have an Al₂O₃ content of 92 wt. % such that they also served as catalyst. A portion of the natural pozzolan precursor was subjected to conventional milling to serve as a comparative example. The properties of the milled natural pozzolan comparative (C1) and the obtained mechanochemically carbonated natural pozzolan (C2) are shown in the below table.

### Sample D

Mechanochemically carbonated natural pozzolans were produced by inserting 8.0 kg of natural pozzolan precursor (Basalt) into a pressure cell with 100 kg of milling media (ceramic ball bearings of 25.4 mm size). The cell is pressurized with flue gas (CO₂:8-10 vol %; H₂O: 18-20 vol %; O₂:2-3 vol %; N₂:67-72 vol %) to an initial pressure of 448 kPa, and rotated on rollers at 38 RPM for 2 days to obtain mechanochemically carbonated natural pozzolan. The material was used as received. The reaction was initiated at room temperature and no heating or cooling was applied. The ceramic bearings have an Al₂O₃ content of 92 wt. % such that they also served as catalyst. A portion of the natural pozzolan precursor was subjected to conventional milling to serve as a comparative example. The properties of the milled natural pozzolan comparative (D1) and the obtained mechanochemically carbonated natural pozzolan (D2) are shown in the below table.

### Sample E

Mechanochemically carbonated natural pozzolans were produced by inserting 5.0 kg of natural pozzolan precursor (Basalt) into a pressure cell with 100 kg of milling media (ceramic ball bearings of 25.4 mm size). The cell is pressurized with flue gas (CO₂:8-10 vol %; H₂O: 18-20 vol %; O₂:2-3 vol %; N₂:67-72 vol %) to an initial pressure of 448 kPa, and rotated on rollers at 38 RPM for 2 days to obtain mechanochemically carbonated natural pozzolan. The material was used as received. The reaction was initiated at room temperature and no heating or cooling was applied. The ceramic bearings have an Al₂O₃ content of 92 wt. % such that they also served as catalyst. A portion of the natural pozzolan precursor was subjected to conventional milling to serve as a comparative example. The properties of the milled natural pozzolan comparative (E1) and the obtained mechanochemically carbonated natural pozzolan (E2) are shown in the below table.

### Sample F

Mechanochemically carbonated natural pozzolans were produced by inserting 10.0 kg of natural pozzolan precursor (Basalt) into a pressure cell with 100 kg of milling media (ceramic ball bearings of 25.4 mm size). The cell is pressurized with flue gas (CO₂:8-10 vol %; H₂O: 18-20 vol %; O₂:2-3 vol %; N₂:67-72 vol %) to an initial pressure of 448 kPa, and rotated on rollers at 38 RPM for 2 days to obtain mechanochemically carbonated natural pozzolan. The material was used as received. The reaction was initiated at room temperature and no heating or cooling was applied. A portion of the natural pozzolan precursor was subjected to conventional milling to serve as a comparative example. The ceramic bearings have an Al₂O₃ content of 92 wt. % such that they also served as catalyst. The properties of the milled natural pozzolan comparative (F1) and the obtained mechanochemically carbonated natural pozzolan (F2) are shown in the below table.

### Sample G

Mechanochemically carbonated natural pozzolans were produced by inserting 8.6 kg of natural pozzolan precursor (Basalt) into a pressure cell with 100 kg of milling media (ceramic ball bearings of 25.4 mm size). The cell is pressurized with flue gas (CO₂:8-10 vol %; H₂O: 18-20 vol %; O₂:2-3 vol %; N₂:67-72 vol %) to an initial pressure of 448 kPa, and rotated on rollers at 38 RPM for 2 days to obtain mechanochemically carbonated natural pozzolan. The material was used as received. The reaction was initiated at room temperature and no heating or cooling was applied. The ceramic bearings have an Al₂O₃ content of 92 wt. % such that they also served as catalyst. A portion of the natural pozzolan precursor was subjected to conventional milling to serve as a comparative example. The properties of the milled natural pozzolan comparative (G1) and the obtained mechanochemically carbonated natural pozzolan (G2) are shown in the below table.

### Sample H

Mechanochemically carbonated natural pozzolans were produced by inserting 10.0 kg of natural pozzolan precursor (Tuff stone) into a pressure cell with 100 kg of milling media (ceramic ball bearings of 25.4 mm size). The cell is pressurized with flue gas (CO₂:8-10 vol %; H₂O: 18-20 vol %; O₂:2-3 vol %; N₂:67-72 vol %) to an initial pressure of 448 kPa, and rotated on rollers at 38 RPM for 2 days to obtain mechanochemically carbonated natural pozzolan. The material was used as received. The reaction was initiated at room temperature and no heating or cooling was applied. The ceramic bearings have an Al₂O₃ content of 92 wt. % such that they also served as catalyst. A portion of the natural pozzolan precursor was subjected to regular milling to serve as a comparative example. The properties of milled the natural pozzolan comparative (H1) and the obtained mechanochemically carbonated natural pozzolan are shown in the below table (H2).

| | | | | DLS | | CO₂ | | SAI | SAI |
|---|---|---|---|---|---|---|---|---|---|
| | Particle Size Distribution | | | surface | Total | content | | 7- | 28- |
| | D10 | D50 | D90 | area | Carbon | (by | % Water | day, | day, |
| Sample | (μm) | (μm) | (μm) | (m²/g) | (wt. %) | TGA) | Demand | % | % |
| A1 | 1.762 | 9.669 | 48.90 | 0.584 | 0.184 | 0.87 | 117.1 | 84 | 110 |
| A2 | 1.680 | 12.31 | 46.95 | 0.568 | 0.401 | 0.94 | 101.7 | 96 | 113 |
| B1 | 2.0 | 28.0 | 90.0 | — | 0.069 | 0.2 | 103.5 | 60 | 83 |
| B2 | 0.969 | 2.396 | 8.398 | 1.138 | 0.182 | 0.7 | 91.3 | 101 | 113 |
| C1 | 3.0 | 32.0 | 90.0 | — | — | — | — | 74 | 109 |
| C2 | 0.928 | 4.769 | 25.53 | 0.910 | — | — | 90.9 | 78 | 133 |
| D1 | 1.4 | 12.0 | 63.0 | — | — | — | — | 76 | 78 |
| D2 | 0.979 | 5.339 | 26.74 | 0.858 | 2.63 | — | — | 123 | 123 |
| E1 | 1.6 | 15.0 | 75.0 | — | — | — | — | 75 | 79 |
| E2 | 0.942 | 5.685 | 37.91 | 0.861 | — | — | — | 109 | 108 |
| F1 | 1.6 | 15.0 | 63.0 | — | — | — | — | 78 | 79 |
| F2 | 0.894 | 3.981 | 30.07 | 0.968 | 0.390 | — | 92.8 | 112 | 113 |
| G1 | 1.4 | 12.0 | 63.0 | — | — | — | — | 71 | 75 |
| G2 | 0.944 | 5.332 | 34.68 | 0.879 | 0.905 | — | 96.9 | 125 | 123 |
| H1 | 1.6 | 15.0 | 63.0 | — | — | — | — | 78 | 79 |
| H2 | 0.905 | 4.023 | 32.06 | 0.958 | 0.865 | — | 100 | 110 | 117 |

As can be observed from the Strength Activity Index (SAI) measurements and the water demand measurements, the mechanochemically carbonated natural pozzolan of the present invention provides an unexpectedly reduced water demand and increased strength compared to milled control samples and even compared to the Portland cement control.

1.-16. (canceled)

17. A mechanochemically carbonated natural pozzolan material obtainable by carbonation of a natural pozzolan precursor, wherein the mechanochemically carbonated natural pozzolan has a specific surface area within the range of 0.5-50 m²/g and wherein
the ratio of the total carbon content of the mechanochemically carbonated natural pozzolan to the total carbon content of the natural pozzolan precursor is at least 1.5:1; and/or
the ratio of the CO2 content of the mechanochemically carbonated natural pozzolan to the CO2 content of the natural pozzolan precursor is at least 1.1:1, wherein the CO₂ content is determined as the mass loss above 450° C. measured by TGA employing a temperature trajectory wherein the temperature was increased from room temperature to 800° C. at a rate of 10° C./min.

18. The mechanochemically carbonated natural pozzolan of claim 17, having one of the following characteristics:
a D10 within the range of 0.005-10 μm;
a D50 within the range of 0.1-50 μm;
a D90 within the range of 0.5-300 μm.

19. The mechanochemically carbonated natural pozzolan of claim 17, having all three of the following characteristics:
a D10 within the range of 0.005-10 μm;
a D50 within the range of 0.1-50 μm;
a D90 within the range of 0.5-300 μm.

20. The mechanochemically carbonated natural pozzolan of claim 17, having a CO2 content of more than 0.5 wt. % (by total weight of the mechanochemically carbonated natural pozzolan), wherein the CO2 content is determined as the mass loss above 450° C. measured by TGA-MS employing a temperature trajectory wherein the temperature was increased from room temperature to 800° C. at a rate of 10° C./min and then decreased to room temperature at a rate of 10° C./min.

21. The mechanochemically carbonated natural pozzolan of claim 17, which has a total carbon content of at least 0.25 wt. %, and wherein the natural pozzolan is a zeolite.

22. The mechanochemically carbonated natural pozzolan of claim 17, which has a strength activity index, SAI, at day 7 determined according to ASTM C311/C311M-22 which is at least 90%, and which has a SAI at day 28 which is at least 100%.

23. The mechanochemically carbonated natural pozzolan of claim 17, which has a strength activity index, SAI, at day 7 determined according to ASTM C311/C311M-22 which is at least 90%, and which has a SAI at day 28 which is at least 120%.

24. A method for producing a mechanochemically carbonated natural pozzolan, said method comprising the following steps:
a) providing a feedstock comprising or consisting of a natural pozzolan precursor;
b) providing a gas comprising at least 0.5 vol % CO2;
c) introducing said feedstock and said gas into a mechanical agitation unit; and
d) subjecting the material of said feedstock to a mechanical agitation operation in the presence of said gas in said mechanical agitation unit.

25. The method of claim 24, wherein the natural pozzolan precursor is a particulate material which has a specific surface area of less than 20 m²/g.

26. The method of claim 24, wherein the mechanical agitation operation of step (d) comprises grinding or milling.

27. The method of claim 24, wherein the gas provided in step (b) is a combustion flue gas.

28. The method of claim 24, wherein the step (d) is performed:
at a pressure of less than 10000 kPa; and
at a temperature of less than 150° C.

29. The method of claim 24, wherein the step (d) is performed:
at a pressure of less than 2500 kPa; and
at a temperature of less than 100° C.

30. The method of claim 24, wherein the feedstock provided in step (a) is a solid feedstock having a moisture content of less than 30 wt. % (by total weight of the solid feedstock).

31. The method of claim 24, wherein carbonation, size reduction and/or surface area increase are effected during step (d) such that
the ratio of the total carbon content of the mechanochemically carbonated natural pozzolan obtained in step (d) to the total carbon content of the natural pozzolan precursor of step (a) is at least 1.5:1.

32. The method of claim 24, wherein carbonation, size reduction and/or surface area increase are effected during step (d) such that
the ratio of the total carbon content of the mechanochemically carbonated natural pozzolan obtained in step (d) to the total carbon content of the natural pozzolan precursor of step (a) is at least 1.5:1;
and the ratio of the CO2 content of the mechanochemically carbonated natural pozzolan obtained in step (d) to the CO2 content of the natural pozzolan precursor of step (a) is at least 1.2:1, wherein the CO2 content is determined as the mass loss above 450° C. measured by TGA employing a temperature trajectory wherein the temperature was increased from room temperature to 800° C. at a rate of 10° C./min.

33. The method of claim 24, wherein carbonation, size reduction and/or surface area increase are effected during step (d) such that the ratio of the D50 of the mechanochemically carbonated natural pozzolan obtained in step (d) to the D50 of the natural pozzolan precursor of step (a) is less than 0.8:1.

34. The method of claim 24, wherein carbonation, size reduction and/or surface area increase are effected during step (d) such that the method has all three, of the following characteristics
the ratio of the CO2 content of the mechanochemically carbonated natural pozzolan obtained in step (d) to the CO2 content of the natural pozzolan precursor of step (a) is at least 1.5:1, wherein the CO2 content is determined as the mass loss above 450° C. measured by TGA employing a temperature trajectory wherein the temperature was increased from room temperature to 800° C. at a rate of 10° C./min;
the ratio of the D50 of the mechanochemically carbonated natural pozzolan obtained in step (d) to the D50 of the natural pozzolan precursor of step (a) is less than 0.8:1;
the ratio of the specific surface area of the mechanochemically carbonated natural pozzolan obtained in step (d) to the specific surface area of the natural pozzolan precursor of step (a) is at least 2:1.

35. The method of claim 24, wherein the natural pozzolan precursor is selected from intermediate (comprising 52-66 wt % SiO2), acidic (comprising >66 wt % SiO2), basic (comprising 45-52 wt % SiO2) or ultrabasic (comprising <45 wt % SiO2) natural pozzolans.

36. A composition comprising a mechanochemically carbonated natural pozzolan of claim 17, and a further material selected from the group consisting of asphalt, geopolymers, cement, polymers, and combinations thereof.
